(19) United States
(12) Patent Application Publication
(10) Pub. No.: US 2008/0285131 A1
(43) Pub. Date: Nov. 20, 2008

(54) Forced air environmental separator, and method of making the same

(76) Inventors: Kevin J. O'Kane, Studio City, CA (US); Martin H. Abbott, Arlington, VA (US)

Correspondence Address: NIXON & VANDERHYE, PC, 901 NORTH GLEBE ROAD, 11TH FLOOR, ARLINGTON, VA, 22203, US

(21) Appl. No.: 11/802,085

(22) Filed: May 18, 2007

(51) Int. Cl. G03B 17/02

(52) U.S. Cl. 359/509

(57) ABSTRACT

Certain example embodiments of this invention relate to forced air environmental separators and/or methods of making the same that are capable of reducing the number and/or amount of deposits (e.g., moisture and/or debris) that form on the lens(es) of viewing devices that reduce the viewing quality and/or experience. In certain example embodiments, an air supply may be configured to supply a flow of pressurized air. A collar may include a plurality of holes formed therein. The plurality of holes may be disposed at one or more angles such that the flow of pressurized air is capable of flowing therethrough. A conduit may connect the air supply to the collar such that the flow of pressurized air flows from the air supply through the conduit to the collar. Certain example embodiments may be used in connection with, for example, a video camera, still camera, telescope, binoculars, glasses or goggles, and/or scope. Certain example embodiments may be used for, for example, sporting events, amateur or professional still photography, wildlife photography, hunting, traffic cameras (e.g., red light cameras, speeding cameras, etc.), surveillance, astronomy, weather watching, special effects, stunt photography, concerts, movie and/or television products, skiing, motor cross, emergency response, etc.

### FIELD OF THE INVENTION

Certain example embodiments of this invention relate to techniques for improving the quality of viewing experiences using a viewing device such as, for example, video cameras, still cameras, telescopes, binoculars, scopes, glasses or goggles, etc. More particularly, certain example embodiments of this invention relate to forced air environmental separators and/or methods of making the same that are capable of reducing the number and/or amount of deposits (e.g., moisture and/or debris) that form on the lens(es) of viewing devices that reduce the viewing quality and/or experience.

### BACKGROUND AND SUMMARY OF EXAMPLE EMBODIMENTS OF THE INVENTION

Hundreds of thousands of dollars are spent each year to purchase the latest and best viewing devices, with such viewing devices including, for example, video cameras, still cameras, telescopes, binoculars, scopes, glasses or goggles, etc. Indeed, individuals, corporations, and governments purchase new viewing devices every year to replace older models, for example, with newer models that include improved viewing features. Such improved viewing features may include better qualities lenses, higher resolution image and/or video capture, more highly powered zooms, etc. Other individuals, corporations, and governments are first-time purchasers of viewing devices.

In many cases, individuals, corporations, and governments use such viewing devices for a variety of purposes, including photography, video, stargazing, hunting, etc. The viewing device typically may become a medium through which individuals observe and/or capture special times. Alternatively or in addition, the viewing device may be an integral part of a broadcasting corporation. In still other example instances, governments may requires such devices when responding to emergency situations (e.g., in the case of first responders, emergency care providers, relief workers, etc.). Regardless of the reason for the use, the occasion, and/or the particular viewing device, in general, individuals, corporations, and governments invest time and money in the same, hoping to obtain a quality end-product that meets or exceeds their expectations.

Unfortunately, despite the above-noted and/or other improvements, viewing devices in general suffer from several inherent disadvantages. For example, moisture caused by, for example, rain, snow, sleet, ice, etc., as well as debris including dust, dirt, pollen, and other materials may come into contact with the lens of the viewing device. This may obstruct the view and/or result in a degraded image or image quality and/or video being captured and/or broadcast. Indeed, the viewing opportunity may be completely lost in some cases.

FIG. 1 is a typical outdoor situation in which moisture may form on a camera lens, causing a broadcast image to be degraded. In FIG. 1, a video camera 102 including a lens 104 is located outside. The video camera 102 may be stationary, a standard pan-tilt-zoom camera, or it may be mobile. In the example of FIG. 1, the video camera 102 is trained on the field of view 106 and rain 108 is falling from above. If, for example, the winds change, the camera is moved in a particular direction, or the rain 108 for some reason falls in a direction other than straight up-and-down (which is likely the case, particularly in draft-prone areas), moisture may collect on the lens. The resulting captured image and resulting broadcast is shown in FIG. 2.

More particularly, FIG. 2 is an example television 202 displaying a live broadcast from the video camera 102 in FIG. 1. The television 202 shows on its screen 204 an image of the field of view 106. Water droplets 206 are at least partially obstructing the view. In this example, the view is only partially obstructed by several well-defined water droplets 106. However, it will be appreciated that the situation may be much worse if, for example, the rain falls more heavily, the wind blows more strongly, etc. Indeed, the field may be completely unperceivable in certain circumstances. This reduction in viewing quality may result in frustration, missed viewing and/or recording opportunities, lost revenues, lost memories, and/or general disappointment.

As suggested above, such situations arise not only in inclement weather, but also in other situations where deposits may form on the lens. For example, a vehicle kicking up dust, dirt, gravel, etc. may also cause obstructing deposits. Skiing, motor cross, and other activities often present similar challenges. Various indoor events also may cause the same or similar situations.

Thus, it will be appreciated that there is a need in the art for techniques that overcome one or more of the above noted disadvantages and/or provide better viewing opportunities with respect to viewing devices.

One aspect of certain example embodiments of this invention relates to techniques for reducing the number and/or amount of deposits forming on a lens of a viewing device.

Another aspect of certain example embodiments relates to techniques for forcing air through a plurality of holes disposed around a collar of a forced air environmental separator apparatus.

Yet another aspect of certain example embodiments relates to the plurality of holes in the collar of the forced air environmental separator being disposed at one or more angles so as to focus the air into one or more focal points to form, for example, a cone and/or pyramid of air.

Still another aspect of certain example embodiments relates to a forced air environmental separator that is connectable to a viewing device and/or built into viewing device itself.

Certain example embodiments may be used in connection with, for example, a video camera, still camera, telescope, binoculars, glasses or goggles, and/or a scope.

Certain example embodiments may be used for, for example, sporting events, amateur or professional still photography, wildlife photography, hunting, surveillance, traffic cameras (e.g., red light cameras, speeding cameras, etc.), astronomy, weather watching, special effects, stunt photography, concerts, movie and/or television products, skiing, motor cross, emergency response, etc.

According to certain example embodiments, a forced air environmental separator for use with a viewing device configured to reduce a number and/or amount of deposits from forming on a lens of the viewing device is provided. An air supply may be configured to supply a flow of pressurized air. A collar may include a plurality of holes formed therein. The plurality of holes may be disposed at one or more angles such that the flow of pressurized air is capable of flowing therethrough. A conduit may connect the air supply to the collar such that the flow of pressurized air flows from the air supply through the conduit to the collar.

According to certain other example embodiments, a viewing device comprising a lens and a forced air environmental separator configured to reduce a number and/or amount of deposits from forming on the lens of the viewing device is provided. The forced air environmental separator of the viewing device may comprise an air supply configured to supply a flow of pressurized air. A collar may include a plurality of holes formed therein, with the collar being at least as big as the lens, and with the plurality of holes being disposed at one or more angles such that the flow of pressurized air is capable of flowing therethrough. A conduit may connect the air supply to the collar such that the flow of pressurized air flows from the air supply through the conduit to the collar.

According to certain other example embodiments, a method of reducing the number of deposits that form on a lens of a viewing device is provided. A supply of pressurized gas may be provided from an air source. The supply of pressurized gas may be forced from the air source through a tube into a collar having a plurality of holes disposed therein. The supply of pressurized gas may be focused into at least one focal point at one or more predetermined locations relative to the lens and/or collar.

These aspects and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a typical outdoor situation in which moisture may form on a camera lens, causing a broadcast image to be degraded;

FIG. 2 is an example television displaying a live broadcast from the video camera in FIG. 1;

FIG. 3a is an example forced air environmental separator device, in accordance with an example embodiment;

FIG. 3b is another example forced air environmental separator device, in accordance with an example embodiment;

FIG. 4a is a simplified cross-sectional view of the example forced air environmental separator device of FIG. 3a, in accordance with an example embodiment;

FIG. 4b is a partial perspective view of the example forced air environmental separator device of FIG. 3a, in accordance with an example embodiment;

FIG. 5 is a video camera including a forced air environmental separator device of FIG. 3a, in accordance with an example embodiment; and

FIG. 6 is an illustrative flowchart showing a method for reducing the number of deposits that may form on a lens of a viewing device.

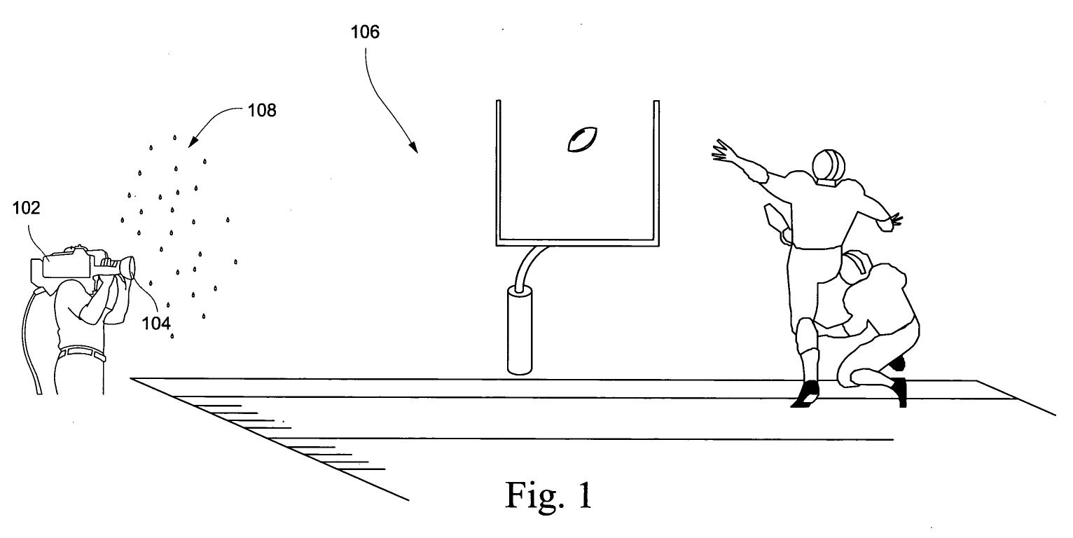

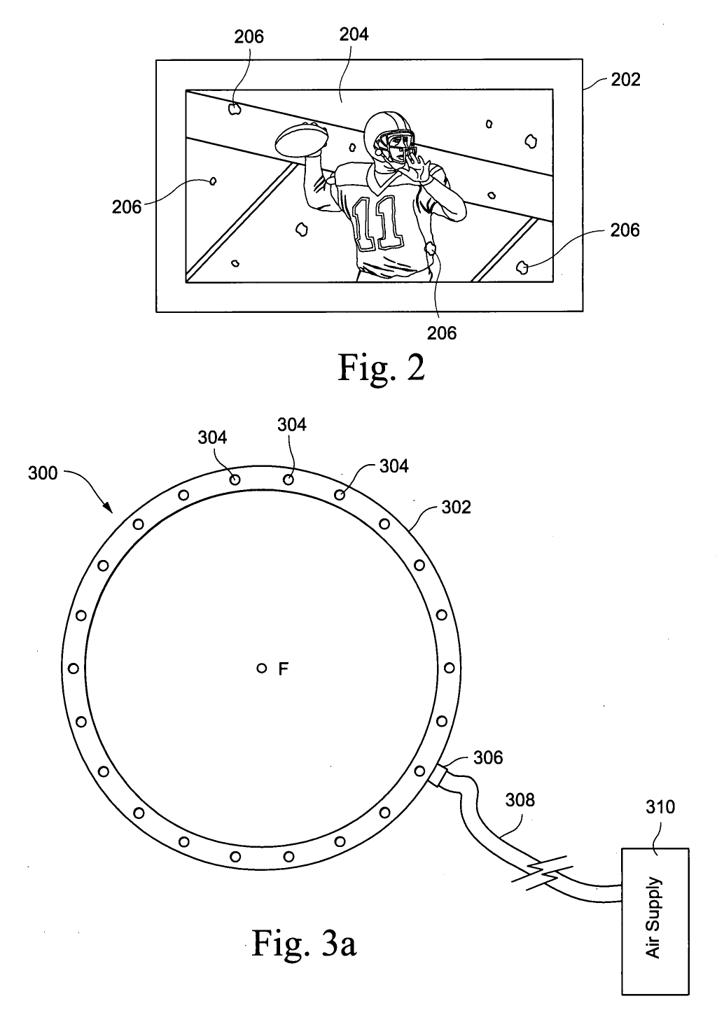

### DETAILED DESCRIPTION OF EXAMPLE EMBODIMENTS OF THE INVENTION

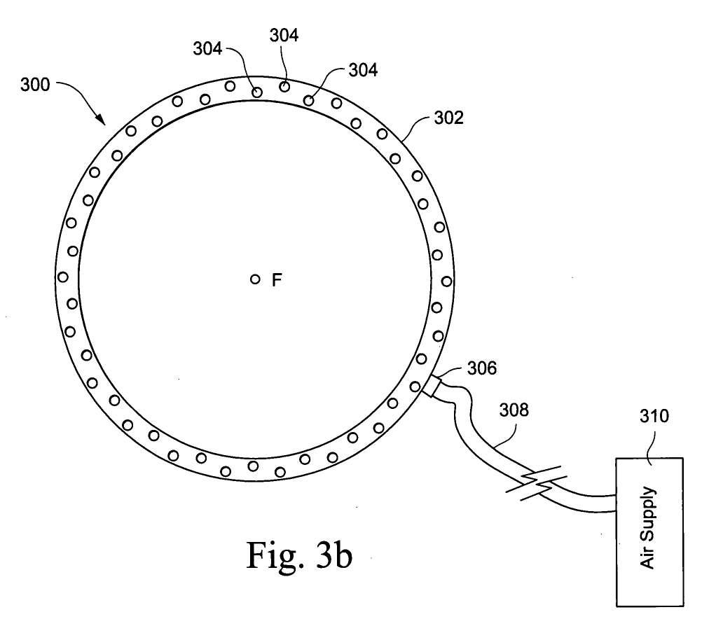

Referring now more particularly to the drawings, FIG. 3a is an example forced air environmental separator device 300, in accordance with an example embodiment. The separator device 300 may comprise a substantially circular collar 302 in a size suitable for being disposed around a lens of a camera. As lenses vary in size, the present invention itself is not limited to any particular size. Moreover, as lenses may be of different shapes (e.g., substantially rectangular, substantially ovular, substantially square-shaped, etc.), the collar 302 itself may be replaced with a correspondingly shaped structure suitable for the particular lens on the viewing device. Of course, it will be appreciated that a collar 302 of a different shape may be located around a smaller lens of a viewing device.

Disposed around the collar 302 are a series of holes 304. It will be appreciated that any number of holes 304 may be used, and that the locations thereof are not restricted to any particular configuration. For example, the holes 304 may be disposed completely or only partially around the collar 302. The holes 304 may be disposed at one or more angles. As described in greater detail below, this angling of the holes may allow air to be focused into one or more focal points, thereby establishing a buffer zone of air between the lens and debris or moisture. Furthermore, the air may angled inwardly in certain example embodiments to allow deposits to be removed and/or to cause the lens to be cleaned. Also, the holes 304 may be of a uniform diameter, although the present invention is not so limited. The holes 304 may be formed in the collar, bored or drilled into the collar, etc. In certain example embodiments, the holes 304 will not go all the way through the collar (e.g., and the collar 302 may be at least partially hollow to allow air to flow therethrough to the holes 304), whereas in certain other example embodiments, the holes 304 may be through-holes capable of receiving a supply of pressurized air directly.

FIG. 3b is another example forced air environmental separator device, in accordance with an example embodiment. As shown in FIG. 3b, the holes 304 are at least partially staggered and/or at least partially overlapping. This configuration may reduce the impact of further spaced apart holes while also having a reduced impact on the profile of the collar 302. Also, the at least partially staggered and/or at least partially overlapping configuration of the holes 302 also may reduce the chances of moisture and/or debris penetrating the buffer while also reducing the gaps (e.g., spaces) between the individual fluids comprising the air buffer.

A gasket or fitting 306 is provided to the collar 302 to allow a flexible conduit 308 (e.g., tube, piping, hose, etc.) to connect to an air supply 310. The air supply 310 may be a supply of compressed air itself and/or it may be an air compressor suitable to provide a supply of compressed air to the collar 302. Air from the air supply 310 may be forced through the flexible conduit 308 through the holes 304 in the collar 302 to form an air-based environmental separator.

It will be appreciated that a power supply may need to be provided in a case where an air compressor is provided. This power supply may be common to the viewing device (e.g., a common power source may power both a video camera and an air compressor), or it may be external to it (e.g., a telescope may have no power source at all in which case a separate power source may need to be provided for an air compressor, it may be disadvantageous to run a digital camera and an air compressor off of a common battery, etc.).

The rate at which air flows from the air supply 310 may be constant, or it may be variable. For example, the rate may be set in dependence on the amount of moisture and/or debris, and/or the force at which is it coming near to the lens. The flow may be triggered by a user action, or it may be automatically actuated. For example, it may be automatically actuated as soon as power is received, upon automatic detection of deposits forming on the lens, etc. In this respect, the flow also may be adjusted upwardly or downwardly automatically.

Also, any suitable air supply may be used. Supplies of compressed air are commercially available, for example, from Roberts Oxygen. Air compressors are commercially available, for example, from Porter and Cable. Certain example embodiments may implement a 150 p.s.i. 6-gallon air compressor from Porter and Cable in connection with a ⅜″ ID air hose with ⅛″ diameter holes spaced ½″ apart. Of course, the present invention is not limited to this or any particular configuration. In general, the air flow and corresponding hole design, air hose diameter, and compressor requirements may be traded off to reflect different requirements. For example, a more highly powered air compressor may be needed for a longer and/or fatter air hose, whereas the hole design may be effective to channel the air at a higher pressure by virtue of a smaller diameter of the air holes compared to a larger diameter of the air hose.

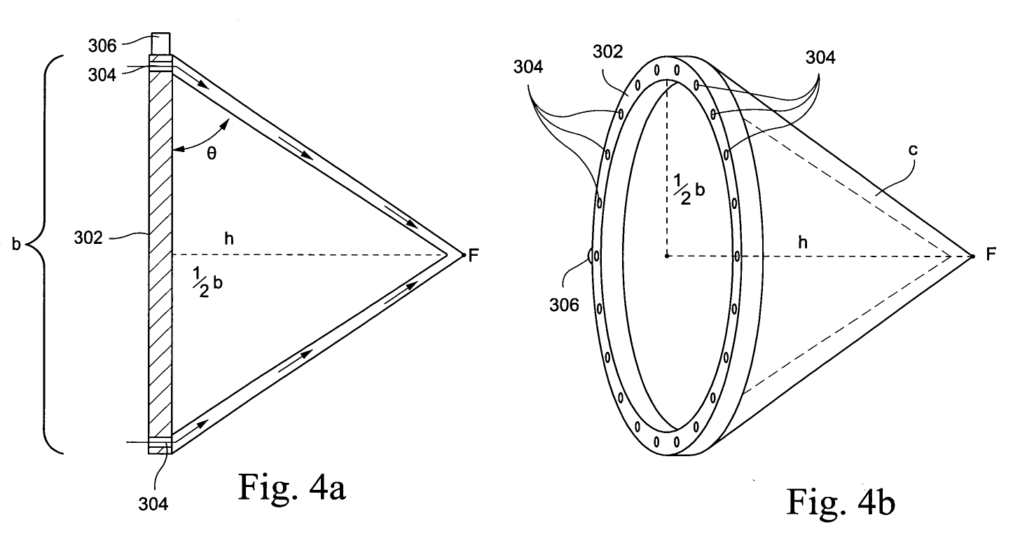

FIG. 4a is a simplified cross-sectional view of the example forced air environmental separator device 300 of FIG. 3a, in accordance with an example embodiment. For the sake of simplicity, the cross-section will be described as being a triangle, although it may be more appropriately thought of as a degenerate conic section (e.g., the rotation of which forms the cone described below with reference to FIG. 4b). Air from the air supply 310 is forced through the holes 304. The holes 304 are disposed at an angle so as to force the air from the face of the collar 302 at an angle θ, causing the air to be focused at point F. The length of the face of the collar 302 (e.g., the collar 302 diameter in the case where it is circular) is labeled b, and the distance from the center of the face of the collar 302 to the focal point F is labeled h. In this example, two right triangles are formed. The mathematical relationship may be modeled as sin θ=h/(½ b). Thus, to focus the air into a single focal point F, the angle of the holes 304 should be θ=sin⁻¹ h/(½ b).

As noted above, differently shaped collars 302 may require a plurality of angles to define a different air structure. One alternative shape for the collar 302 may be substantially rectangular, thus producing a substantially pyramidal shaped air buffer with a substantially rectangular base. In such a case, it is more convenient to think of the substantially pyramidal air structure in terms of the triangular faces comprising the substantially pyramidal air structure, which will be substantially isosceles in shape. Two different substantially isosceles triangles will be needed to comprise the faces, corresponding to the major and minor axes. For the triangles extending from the major axes, the base of the isosceles triangle will be the length of the major axis. For the triangles extending from the minor axes, the base of the isosceles triangle will be the length of the minor axis. The point at which all isosceles triangles will meet is the focal point F having a height h from the lens' surface. Based on these factors, it is possible to determine the angles at which the holes 304 for generating the isosceles triangles should be disposed. For the triangles extending from the major axes, the angle should be θ_{major axis}=sin⁻¹ h(½ length_{minor axis}). Similarly, for the triangles extending from the minor axes, the angle should be θ_{minor axis}=sin⁻¹ h/(½ length_{major axis}). Of course, it will be appreciated that other shapes may be used for the base (e.g., a square shape, an oval shape, etc.), but the same or similar techniques as described above may be used to determine the angle(s) at which the holes 304 should be directed to form a focal point F at a given height h away from the surface of the lens and/or collar 302.

Also, the same or similar methods may be used if a configuration similar to an at least partially staggered and/or at least partially overlapping configuration (e.g., as shown in FIG. 3b) is implemented. In certain example embodiments implementing such configurations, multiple angles corresponding to the different positions of the holes with respect to the base may need to be used to account for the different base sizes. In certain other example embodiments, a common angle may be used for all holes, resulting in a “thicker” air buffer because in such embodiments the multiple flows of air will focus, on average, at point F.

The air may be focused at any distance from the lens, e.g., 1″, 2″, 3″, etc. The air need not be focused directly in the center of the lens. For example, in certain example embodiments, the air may be focused to a point to one side of the lens and, furthermore, the focal point may be out of the field of view of the imaging device. In such cases, it will be appreciated that the holes 304 will need to be angled differently depending on their location around the collar 304.

It will be appreciated that the amount of air forced through the holes 304 will depend at least in part on the size of the holes 304. This, in turn, may impact the quantity of debris and/or moisture that may be separated from the lens. Accordingly, the holes need not be uniformly sized, as it will be appreciated that in some situations (e.g., stationary filming) that little debris and/or moisture will float upwards, whereas this may not be the case in certain other situations (e.g., when a camera is recording footage from the back of an open jeep that kicks up dust, debris, gravel, etc.). In certain example embodiments, mechanical means may be used to adjust the aperture of the holes 304. For example, a simple swivelable dial may be used to adjust the apertures of the holes 304 to allow more or less air to flow therethrough. Alternatively or in addition, the holes may be redirected through mechanical means such as, for example, a swivelable dial, a prong for each hole allowing the hole to be redirected, etc.

FIG. 4b is a partial perspective view of the example forced air environmental separator device 300 of FIG. 3a, in accordance with an example embodiment. As before, the holes 304 around the collar 302 force the air into a focal point F. As is clearly shown in FIG. 4b, a cone C is formed, thereby reducing the amount of debris and/or moisture that may come into contact with the lens.

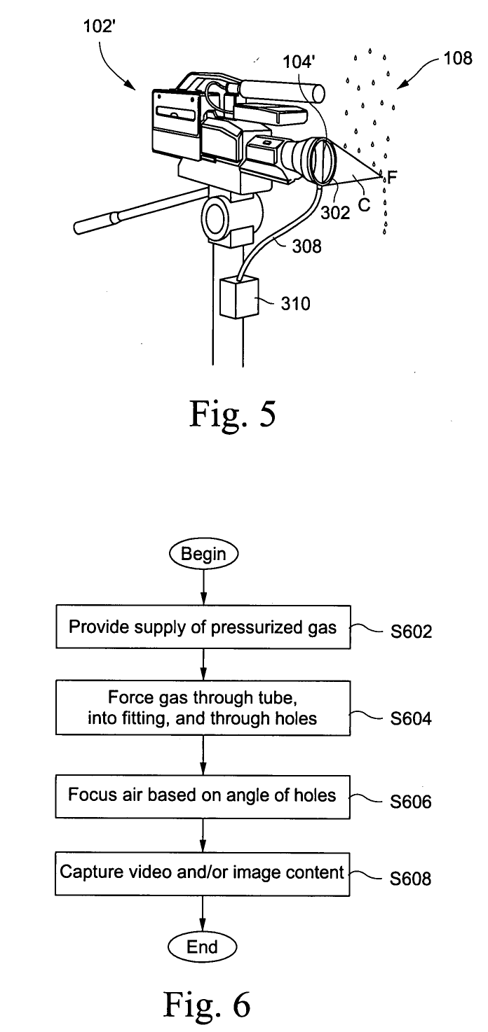

FIG. 5 is a video camera 102′ including a forced air environmental separator device 300 of FIG. 3a, in accordance with an example embodiment. Again, the air supply 310 provides air through the flexible conduit 308 to the collar 302. Here, a cone C is formed with its focus at point F. Any moisture and/or debris 108 will be forced outward from the lens 104′ towards the focal point F, where it will simply drop, potentially out of view of the camera, and advantageously with a reduced effect on the viewing, recording, and/or broadcasting experience.

In certain example embodiments, the collar 302 may be built into the video camera 102′ itself. In certain other example embodiments, the collar 302 may be connected to the outside of and/or around the lens 104′. In still other example embodiments, the collar 302 may be removably connected to the lens, e.g., via interlocking grooves or races existing on certain conventional video cameras (e.g., of the type that allow consumers to switch lenses, apply filters, etc.). In such a case, the collar 302 may be disposed between the camera and the lens, or on the lens after the lens attaches to the camera. It will be appreciated that although a video camera 102′ is shown in FIG. 5, the present invention is not limited to this or any particular type of imaging device. For example, certain example embodiments may be used in connection with still cameras, digital cameras, binoculars, telescopes, scopes, glasses or goggles, etc., or any type of viewing device. Thus, in certain example embodiments, the collar may be at least as big as the lens it is to protect, whereas the collar may be more closely fitted to the size of the lens in certain other examples.

FIG. 6 is an illustrative flowchart showing a method for reducing the number of deposits that may form on a lens of a viewing device. In step S602, a supply of pressurized gas is provided. The pressurized gas may come from a supply of pressurized air, or an air compressor may compress gas during operation. The gas may be forced through a tube into a fitting and through a plurality of holes disposed around a collar located around a lens in step S604. In step S606, Based at least in part on the angle(s) of the holes, the air may be focused into one or more focal points at one or more predetermined locations relative to the lens and/or collar. Depending at least in part on the geometry of the lens, collar, and/or configuration of the holes, an air-based environmental separator will be formed as, for example, a cone, a pyramid, etc. It will be appreciated that these focal points may be located directly in the center of the lens, to the side, etc. The chances of deposits forming on the lens therefore may be reduced, allowing video and/or image content to be captured clearly and/or cleanly in step S608.

It will be appreciated that the forced air environmental separation techniques of certain example embodiments may be used in any number of fields. Applications may include, for example, sporting events, amateur or professional still photography, wildlife photography, hunting, surveillance, traffic cameras (e.g., red light cameras, speeding cameras, etc.), astronomy, weather watching, special effects, stunt photography, concerts, movie and/or television products, skiing, motor cross, emergency response, etc.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A forced air environmental separator for use with a viewing device configured to reduce a number and/or amount of deposits from forming on a lens of the viewing device, comprising:
an air supply configured to supply a flow of pressurized air;
a collar including a plurality of holes formed therein, the plurality of holes being disposed at one or more angles such that the flow of pressurized air is capable of flowing through the holes to reduce the number and/or amount of deposits from forming on the lens of the viewing device; and
a conduit connecting the air supply to the collar so that the flow of pressurized air flows from the air supply through the conduit to the collar.

2. The forced air environmental separator of claim 1, wherein the holes are disposed at the plurality of angles so as to cause the flow of pressurized air to converge at least one focal point.

3. The forced air environmental separator of claim 1, wherein the holes are at least partially staggered and/or at least partially overlapping.

4. The forced air environmental separator of claim 2, wherein the at least one focal point is located in front of the lens at a point along a line extending perpendicular to the lens from the lens' center.

5. The forced air environmental separator of claim 2, wherein the holes are disposed at the plurality of angles so as to cause the flow of pressurized air to form a cone and/or pyramid of air, with the collar forming the cone and/or pyramid base.

6. The forced air environmental separator of claim 1, wherein the collar is at least as big as the lens.

7. The forced air environmental separator of claim 1, wherein the collar is substantially oval shaped.

8. The forced air environmental separator of claim 1, wherein the collar is substantially rectangle shaped.

9. The forced air environmental separator of claim 1, wherein the air supply is a supply of compressed air.

10. The forced air environmental separator of claim 1, wherein the air supply includes an air compressor to compress air.

11. The forced air environmental separator of claim 1, wherein the collar further includes one or more grooves to engage with one or more corresponding grooves of the viewing device and/or lens.

12. The forced air environmental separator of claim 1, wherein the viewing device is one or more of a video camera, still camera, telescope, binoculars, glasses or goggles, and/or scope.

13. The forced air environmental separator of claim 1, wherein at least some of the holes are angled or angleable towards the lens.

14. A viewing device, comprising:
a lens; and
a forced air environmental separator configured to reduce a number and/or amount of deposits from forming on the lens of the viewing device, comprising:
an air supply configured to supply a flow of pressurized air;
a collar including a plurality of holes formed therein, the collar being at least as big as the lens, and the plurality of holes being disposed at one or more angles such that the flow of pressurized air is capable of flowing through the holes to reduce a number and/or amount of deposits from forming on the lens; and
a conduit connecting the air supply to the collar such that the flow of pressurized air flows from the air supply through the conduit to the collar.

15. The viewing device of claim 14, wherein the holes are disposed at the plurality of angles so as to cause the flow of pressurized air to converge at least one focal point, and wherein the viewing device is a television camera.

16. The viewing device of claim 14, wherein the holes are at least partially staggered and/or at least partially overlapping.

17. The viewing device of claim 15, wherein the at least one focal point is located in front of the lens at a point along a line extending perpendicular to the lens from the lens' center.

18. The viewing device of claim 15, wherein the holes are disposed at the plurality of angles so as to cause the flow of pressurized air to form a cone and/or pyramid of air, with the collar forming the cone and/or pyramid base.

19. The viewing device of claim 14, wherein the viewing device is one or more of a video camera, still camera, telescope, binoculars, glasses or goggles, and/or scope.

20. A method of reducing the number of deposits that form on a lens of a viewing device, the method comprising:
providing a supply pressurized gas from an air source;
forcing the supply of pressurized gas from the air source through a tube into a collar having a plurality of holes disposed therein; and
focusing the supply of pressurized gas into at least one focal point at one or more predetermined locations relative to the lens and/or collar.
